(19) United States
(12) Patent Application Publication
(10) Pub. No.: US 2006/0266563 A1
(43) Pub. Date: Nov. 30, 2006

(54) Carrying case with integrated electronics system

(76) Inventor: Myron David Kaplan, Sydney (AU)

Correspondence Address: Hugh R. Kress;Browning Bushman P.C., Suite 1800, 5718 Westheimer, Houston, TX, 77057, US

(21) Appl. No.: 11/139,714

(22) Filed: May 27, 2005

(51) Int. Cl. G01G 23/00; G01G 19/00

(52) U.S. Cl. 177/245

(57) ABSTRACT

A carrying case having an integrated electronic system is disclosed. In one embodiment, the carrying case resembles a conventional wheeled suitcase such as is commonly used by airline travelers. One or more load/force sensors are disposed on or near a bottom surface of the suitcase enclosure. Some means of force transfer is provided for ensuring that when the suitcase is resting on a substantially flat surface, the force from the weight of the suitcase itself and all of its contents are exerted on the sensor(s). An electronic system is disposed within the enclosure and is in electrical communication with the sensor(s). A user actuable input such as a pushbutton is mounted on the exterior of the enclosure. The electronic system is responsive to actuation of the input to perform a weighing operation whereby the output(s) from the sensor(s) are interpreted and supplied to an indicator for providing an indication of the weight of the carrying case and its contents. The indicator may be a visual indicator such as a digital display, and/or an audible indicator, such as a voice synthesizer circuit for reading an audible indication of the weight.

### FIELD OF THE INVENTION

This invention relates generally to the field of carrying cases and the like, and more particularly relates to a carrying case having an integral electronic system for performing various functions.

### BACKGROUND OF THE INVENTION

Those of ordinary familiarity with the logistics of traveling, especially traveling by aircraft, will appreciate that there are often constraints imposed on the baggage one uses to carry one's clothing, personal effects, and the like.

In addition to quantity and size restrictions, commercial airlines throughout the world typically impose restrictions on the weight of one's baggage. These restrictions vary from time to time, from country to country, and from airline to airline. Most United States carriers have recently tightened their baggage restrictions, particularly their weight restrictions, and many have increased the fines or surcharges imposed on passengers whose baggage exceeds applicable standards.

Airlines have also become increasingly strict in applying their baggage standards. Weight standards in particular are important to aircraft operators for several reasons: First, the aggregate weight of passengers' baggage carried on an aircraft has an impact on the aircraft's performance and fuel consumption while in flight, and on takeoff and landing. Second, airlines in the United States are required to conform to regulations imposed by the Occupational Health and Safety Administration respecting the maximum weight of items that baggage handlers and other employees are required to lift during the course of performing their duties.

When packing their bags, travelers typically do not have ready access to scales or other weighing devices suitable for determining whether a packed suitcase complies with an airline's weight restrictions, if the traveler even knows what those weight restrictions may be for each airline on which he or she may travel. Moreover, the weight of one's baggage may vary throughout the duration of a given trip, such that a bag may be compliant on one leg of travel but non-compliant on another.

Thus, is it believed that it would be desirable to provide a convenient means by which a traveler may readily ascertain the weight of his or her bag.

### SUMMARY OF THE INVENTION

In view of the foregoing, the present invention is directed to a carrying case such as a conventional suitcase which is provided with a means for displaying the weight of the case, its contents, and any accessories or carry-on bags, such as strap-on bags, briefcases, backpacks, purses, and the like.

In one embodiment of the invention, a suitcase is provided with one or more load/force sensors for sensing the weight of the suitcase. The sensor(s) is/are disposed on or in the suitcase in such a manner that when the suitcase is placed on a surface in a particular orientation, substantially all of the weight of the suitcase (and its contents) is applied to the sensor(s).

In an alternative embodiment of the invention, a suitcase with a handle is provided with one or more load/force sensors that are integrated into the suitcase in such a manner that when the suitcase is held above the ground by the handle, the weight of the suitcase and its contents is exerted on the sensor(s), thereby enabling the suitcase to be weighed.

In accordance with one aspect of the invention, a readout is integrated into the suitcase and positioned such that when the suitcase is oriented to perform the weighing operation, the readout is visible to the person performing the weighing operation.

In any embodiment of the invention, an integrated electronics system is provided for receiving electrical signals from the one or more load/force sensors and causing a visual indication of the sensed weight of the suitcase on the readout. The visual indication can take various forms, including, without limitation, a segmented, numerical digital readout, a bar-graph readout, an analog readout, and so on.

In still another alternative embodiment of the invention, an audible indication of the suitcase's weight is provided either in addition to or instead of the visual indication. Circuitry is provided for generating a synthesized verbal reading of the suitcase's weight, and such circuitry is activated to read out the weight whenever a weighing operation is initiated by the user.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is a schematic diagram of a carrying case with an integrated electronics system in accordance with one embodiment of the invention;

FIG. 2 is a perspective view of the exterior of a carrying case in accordance with one embodiment of the invention;

FIG. 3 is a perspective view of the carrying case of FIG. 2 showing the interior thereof;

FIG. 4 is a top view of the carrying case of FIG. 2;

FIG. 5 is a front view of the carrying case of FIG. 2;

FIG. 6 is a rear view of the carrying case of FIG. 2;

FIG. 7 is a perspective view of a carrying case in accordance with an alternative embodiment of the invention;

FIG. 8 is a perspective view of the carrying case of FIG. 7;

FIG. 9 is a perspective view of a carrying case in accordance with another alternative embodiment of the invention;

FIG. 10 is a perspective view of the carrying case of FIG. 9; and

FIG. 11 is a front view of a carrying case in accordance with still another alternative embodiment of the invention.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant fields.

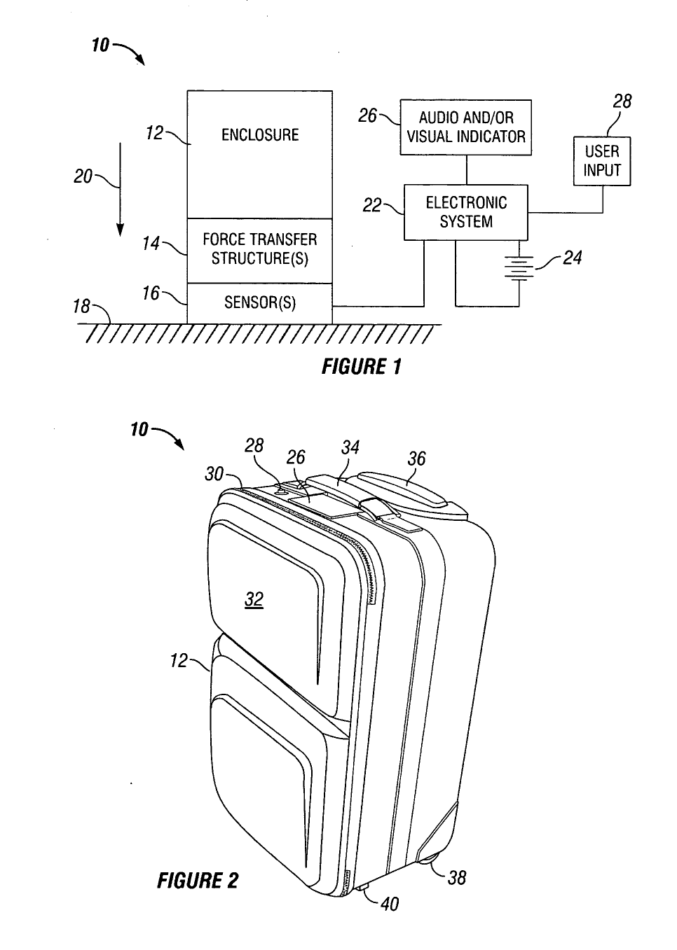

Referring to FIG. 1, there is shown a schematic diagram of a carrying case 10 in accordance with one embodiment of the invention. As shown in FIG. 1, carrying case 10 comprises an enclosure 12 for containing articles to be carried by carrying case 10. In one embodiment, carrying case 10 is a conventional rolling-type suitcase such as is commonly used by airline travelers.

Carrying case 10 further comprises at least one force transfer structure 14 and at least one load/force sensor 16. The force transfer structure(s) 14 and sensor(s) 16 are oriented with respect to one another in such a manner that when carrying case 10 is resting on a surface 18, substantially the entire weight of enclosure 12 and all of its contents (not shown in FIG. 1) exerts a force on sensor(s) 16. That is, force transfer structure(s) 14 serve(s) to transfer to sensor(s) 16 the entire force resulting from the pull of gravity, represented by arrow 20 in FIG. 1, on enclosure 12, its contents, and force transfer structure(s) 14.

With continued reference to FIG. 1, carrying case 10 further comprises an electronic system 22 which is functionally coupled (e.g., electrically or optically) to sensor(s) 16. One type of load/force sensor suitable for the practice of the present invention is a piezoelectric load cell which operates on the principle that the resistance of silicon-implanted piezoresistors will increase when the resistors flex under any applied force. A load/force sensor directs applied force to a silicon-sensing element. The amount of resistance changes in proportion to the amount of force being applied. This change in circuit resistance results in a corresponding output voltage level change. A wide array of load cells suitable for the purposes of the present invention are known and commercially available, and the principles of operation thereof are well understood by those of ordinary skill in the art. The identification of a particular manufacturer and/or model of load cell is not deemed necessary for the purposes of the present disclosure.

In an alternative embodiment of the invention, load/force sensor(s) 16 comprise(s) one or more of the so-called “load beam” or “bending beam” type of sensor, which are also well-known to those of ordinary skill in the art and widely commercially available from any number of suppliers. A bending beam sensor consists of a straight beam attached to a base at one or both ends. Strain gauges are mounted on the beam to measure tension and compression forces applied to the beam. The beam itself often is typically made of a rugged material such as alloy steel or the like.

As shown in FIG. 1, a battery or other suitable power source 24 is provided to supply power to electronic system 22, which in turn is responsible for selectively energizing sensor(s) 16 when a weighing operation is conducted. Preferably, a user-actuable switch 28 is mounted on or otherwise accessible at an exterior surface of enclosure 12. The electronic system 22 is responsive to actuation of switch 28 to selectively energize sensor(s) 16. In this way, power is conserved by having sensor(s) 16 activated only during the brief periods of time necessary to conduct weighing operations. In one embodiment, battery 24 comprises a conventional lithium-based battery, capable of supplying necessary power to the system, in theory, for many years.

Finally, FIG. 1 shows that electronic system 22 is coupled to an audio and/or visual indicator 26, in order to provide audible and/or visual indication of the weight of the enclosure 12 and its contents as sensed by load/force sensor(s) 16 during a weighing operation. In one embodiment, indicator 26 may be a segmented digital numerical display, such as a liquid crystal diode (LCD) display or the like. Alternatively, indicator 26 may be a simple bar-graph display or an analog display. In the presently preferred embodiment of the invention, indictor 26 is an LCD display that is mounted at a location in or on enclosure 12 such that it is visible when the carrying case 10 is placed on a surface 18 and a weighing operation is initiated by actuation of pushbutton 28.

In another alternative embodiment, however, indicator 26 may be implemented as a simple voice synthesizer circuit that is programmed to audibly read out the weight of the carrying case 10 upon initiation of a weighing operation. Various integrated-circuit based voice synthesizer circuits capable of performing this function are commercially available, such as, for example, from Aplus Integrated Circuits, Inc., Taipei, Taiwan (http://www.aplusinc.com.tw).

Those of ordinary skill in the art having the benefit of the present disclosure will appreciate that electronic system 22 may be implemented in any one of a number of forms. In one embodiment, electronics 22 take the form of a simple integrated circuit microcontroller and associated integrated or external memory. In another embodiment, electronics 22 are implemented as an application-specific integrated circuit (ASIC) or the like. In still another embodiment, electronics 22 can be implemented using discrete electronic components. It is believed that the design and implementation of electronics capable of performing the functions described herein would be a matter of routine engineering to persons of ordinary skill in the art, and description of specific implementation details is unnecessary for the purposes of the present disclosure.

Turning now to FIG. 2, there is shown a perspective view of an implementation of the carrying case 10 shown schematically in FIG. 1. It is to be understood that elements shown in all remaining Figures that are identical to those identified and described in FIG. 1 retain identical reference numerals. As shown in FIG. 2, carrying case 10 comprises an enclosure 12 in the form of a conventional suitcase commonly carried by airline passengers and the like. In the disclosed embodiment, and in accordance with conventional design, enclosure 12 is equipped with a zipper 30 extending around, for example, three edges to permit a lid portion 32 to be opened for packing the enclosure 12 and then closed securely for transport.

Carrying case 10 is further equipped with a fixed handle 34 secured on a top portion of enclosure 12. In accordance with conventional design, carrying case 10 is further equipped with a retractable handle 36 which extends into the interior of enclosure 12 and can be withdrawn upwardly to provide a convenient means for pulling the carrying case 10 along on its wheels 38.

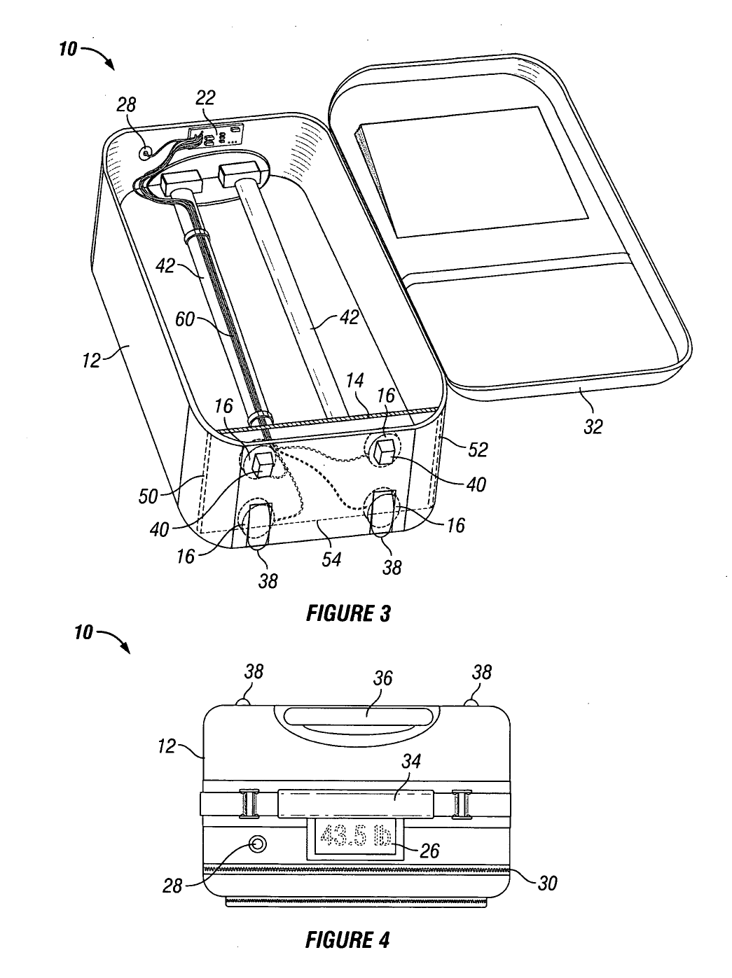

Turning to FIG. 3, there is shown a perspective view of carrying case with zipper 30 unzipped and lid portion 32 in an open position. As can be observed in FIG. 3, and in accordance with the conventional design of suitcases such as in the presently disclosed embodiment, disposed on a bottom surface of enclosure 12 are a plurality of support structures. In particular, in the disclosed embodiment, there are two support posts 40 in addition to the two wheels 38. Together, posts 40 and wheels 38 cooperate to maintain enclosure 12 balanced in an upright position when placed on a reasonably level surface with handles 34 and 36 oriented to the top of enclosure 12.

Also observable in FIG. 3 are two rigid retractable handle conduits 42 extending longitudinally within enclosure 12 from the top to the bottom thereof. These conduits 42 permit the upright portions of the retractable handle to pass into enclosure 12 without interference from whatever contents may be packed inside enclosure 12.

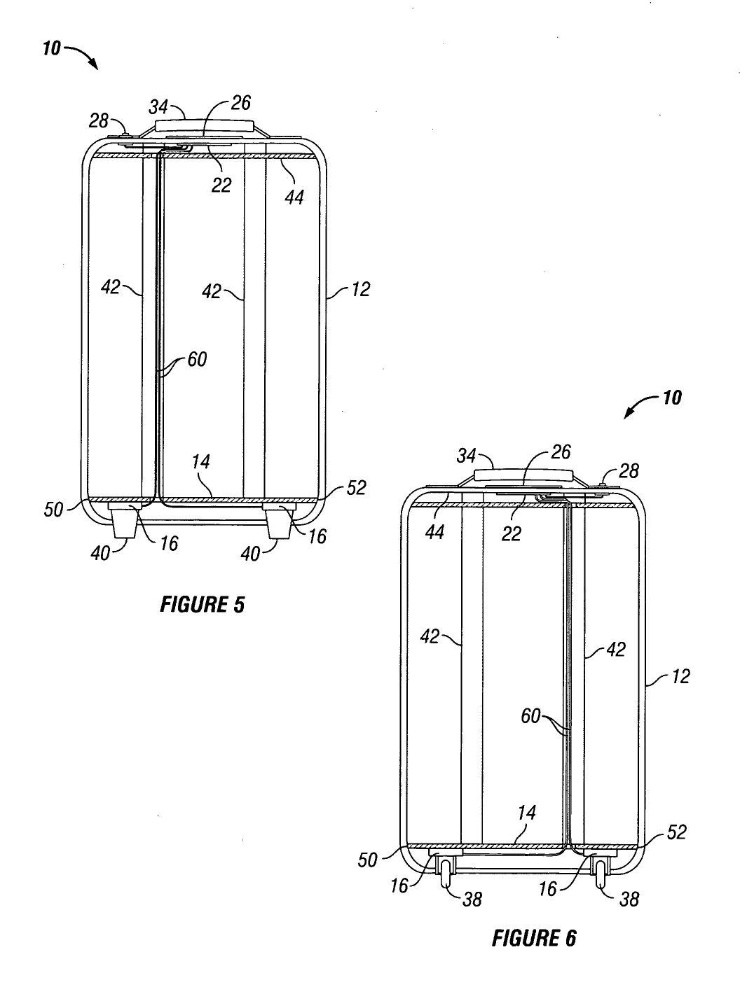

Turning to FIG. 5, there is shown a front view of carrying case 10. (Note in FIG. 5 that lid portion 32 is not shown, for the sake of clarity.) As can be seen in FIG. 5, there is a divider 44 inside enclosure 12 near the top thereof. Divider 44 serves to protect electronics system 22 disposed in enclosure 12, as will be hereinafter described in further detail. (Note that divider 44 is not shown in FIG. 3, in order that other components, such as electronics system 22, can be observed).

Also shown in FIG. 5 is force transfer structure 14 disposed substantially near the bottom of enclosure 12. In the presently disclosed embodiment, structural member force transfer structure 14 takes the form of a rigid planar structure, as can be better observed in FIG. 3, that is fastened along its side edges 50 and 52 and its rear edge 54 to the inside of enclosure 12. On the other hand, as will hereinafter become apparent, force transfer structure 14 can take other forms, such as cross-beams or the like, while still performing the functions to be described below.

Referring again to FIG. 5, as well as to FIG. 6, which shows a rear view of enclosure 12 (with the rear side of enclosure 12 removed to expose the interior thereof), disposed on the underside of force transfer structure 14 are load/force sensors 16. In the presently disclosed embodiment, four load/force sensors 16 are provided. Two load/force sensors 16 are disposed between force transfer structure 14 and support posts 40, and two load/force sensors 16 are disposed between force transfer structure 14 and wheel assemblies 38.

Various load force sensors suitable for the purposes of the present invention are known and readily commercially available. In the disclosed embodiment, sensors 16 are of the common disk-type piezoelectric load/force sensor variety. Those of ordinary skill in the art will recognize that such sensors operate on the principle that the resistance of silicon implanted piezoresistors will increase when the resistors flex under any applied force. Such force sensors are available from many sources, including Measurement Specialties, Inc., Hampton, Va. (http://www.msisensors.com).

In an alternative embodiment, the well-known load-beam-type load/force sensor discussed above, in which a strain gauge measures the strain exerted on an elongate beam by an applied force, may be utilized. It is believed that those of ordinary skill in the art having the benefit of the present disclosure would be readily capable of implementing such an alternative embodiment.

With continued reference to FIGS. 3, 5 and 6, each sensor 16 is coupled to electronics system 22 by means of wires 60. In the disclosed embodiment, wires 60 extend alongside one of the retractable handle conduits 42.

Those of ordinary skill in the art will appreciate by observation of FIGS. 3, 5, and 6, that force transfer structure 14 functions to transfer substantially all of the force exerted by the weight of carrying case 10 and all of its contents to sensors 16. The aggregated output from all sensors 16 therefore accurately reflects the weight of carrying case 10 and all of its contents.

Referring to FIG. 4, user input device 28, in the form of a user-actuable pushbutton, is mounted on the top surface of enclosure 12. Pushbutton 28 is coupled to electronics system 22 to enable the user to initiate a weighing operation.

Use and operation of carrying case 10 as described herein proceeds as follows. When a user wishes to transport items in carrying case 10, the items are loaded into enclosure 12 and lid portion 32 is closed and secured by zipper 30. Carrying case 10 is transported in conventional ways, including either by carrying with fixed handle 34, withdrawing retractable handle 36 and rolling along the ground on wheels 38, and so on.

Should it become necessary or desirable for the user to determine the weight of carrying case 10 and its contents, such as when packing for an airplane flight, the user simply places carrying case 10 in an upright position on a substantially even surface. In this position, the aggregate force exerted on load/force sensors 16 reflects substantially the entire weight of carrying case 10 and its contents.

At this time, to initiate a weighing operation, the user activates pushbutton 28. Electronics system 22 is responsive to actuation of pushbutton 28 to detect the electrical signals from sensors 16 conducted on wires 60. Electronics system 22 then controls the audio and/or visual indicator 26 to indicate audibly and/or visually, the weight of the carrying case and its contents. As can be seen in FIG. 4, in the exemplary embodiment, indicator 26 takes the form of an LCD readout, although the various alternatives noted above, as well as other possible alternative indicators, may be used.

As noted above, the physical configuration of force transfer structure(s) 14 is not limited to the substantially rigid planar structure shown in FIGS. 2 through 6. It is believed that there are essentially limitless possible alternative implementations with respect to the transfer of force to one or more sensors, up to and including an arrangement whereby the load/force sensors are disposed on the exterior of the enclosure, such that the enclosure itself serves as the force transfer structure. In another alternative implementation, wheels 38 and/or support posts 40 may be omitted entirely, with load/force sensors 16 serving as the support mechanism for case 10. Those of ordinary skill in the art having the benefit of this disclosure will recognize that any arrangement in which the full force of weight from carrying case and its contents is brought to bear upon one or more sensors will achieve the desired objectives of the invention, and it is believed that the invention is by no means limited to the purely exemplary embodiment thus far described.

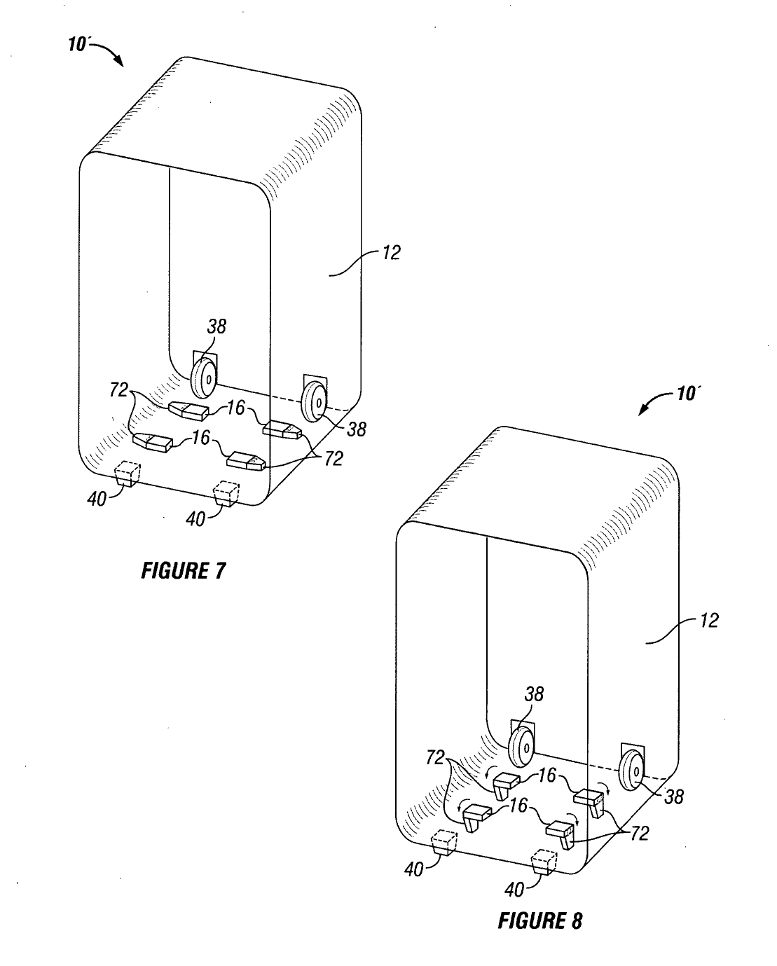

Turning to FIGS. 7 and 8, there is shown a simplified depiction of a carrying case 10′ in accordance with an alternative embodiment of the invention. In the embodiment of FIGS. 7 and 8, a plurality of sensors 16 are disposed directly on the bottom side of the enclosure 12. (Although four sensors are shown in FIGS. 7 and 8, it is to be understood that fewer than four—for example, three—or more than four, may be employed.)

As shown in FIGS. 7 and 8, associated with each sensor 16 is a hinged support 72. During normal use, supports 72 are folded flat against the underside of enclosure 12. In this state, carrying case 10′ is supported by wheels 38 and support posts 40.

As shown in FIG. 8, when it is desired to perform a weighing operation, hinged supports 72 are folded down to project downward from the underside of enclosure 12. In this state, carrying case 10′ is supported entirely by support posts 72, thereby causing the force of the entire weight of carrying case 10′ and its contents to be exerted on sensors 16.

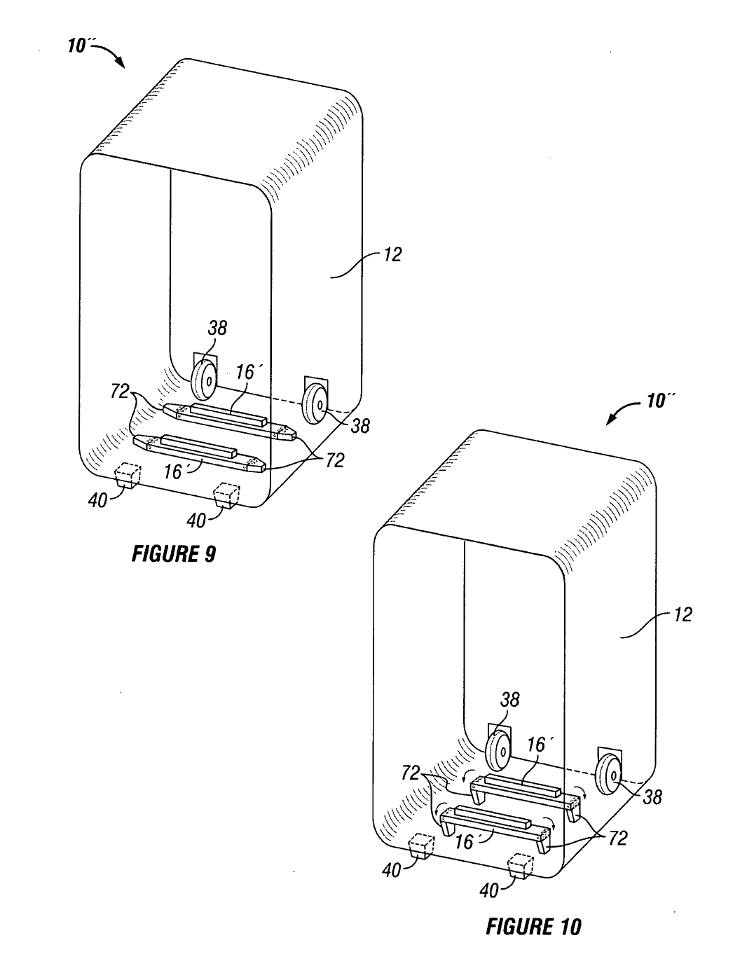

FIGS. 9 and 10 illustrate still another alternative embodiment 10″ of the invention. In the embodiment of FIGS. 9 and 10, sensors 16′ are of the cantilever or “load-beam” variety, and are disposed on the underside of enclosure 12. As in the embodiment of FIGS. 7 and 8, associated with each sensor 16′ are a pair of hinged support posts 72. During normal use, supports 72 are folded up against the underside of the enclosure 12, such that when placed on a surface, carrying case 10″ is supported by wheels 38 and support posts 40, as shown in FIG. 9.

When a weighing operation is to be performed, hinged supports 72 are folded down to the position depicted in FIG. 10, thereby causing the force from the weight of the carrying case 10″ and all of its contents to be brought to bear on sensors 16′.

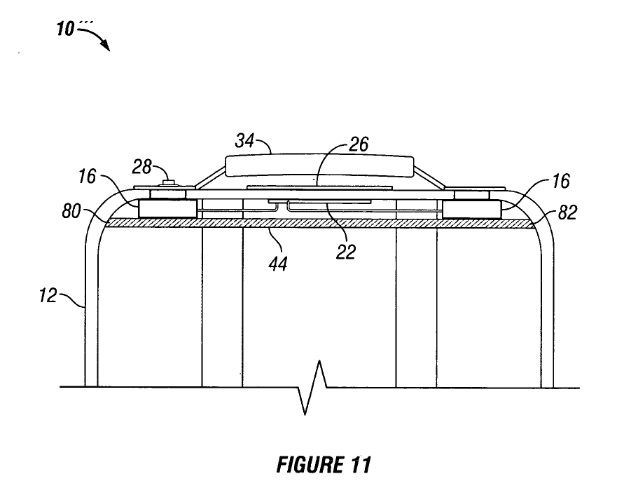

Turning to FIG. 11, there is illustrated yet another alternative embodiment 10′″ of the invention. In the embodiment of FIG. 11, load/force sensors 16 are disposed in a location just beneath each end of fixed handle 34. An upper side of each sensor 16 is mechanically coupled to one end of fixed handle 34. A lower side of each sensor 16 is mechanically coupled to divider 44. Divider 44, in turn, is secured to enclosure 12 at least at each end 80 and 82 thereof. Divider 44, therefore, serves as a tension force transfer structure between carrying case 10′″ and sensors 16.

A weighing operation with the embodiment of FIG. 11 takes place while carrying case 10′″ is being held in the air by handle 34. When so held, the tension force from the weight of carrying case 10′″ and all of its contents is exerted on sensors 16. It is contemplated that in this embodiment, at most two sensors 16 would be needed.

Another alternative embodiment of the invention takes account of a suitcase design commonly in use in which a pullout bracket is provided on the bottom of the suitcase in order to help prevent the suitcase from tipping over when set down on a surface. In this alternative embodiment, one or more of the sensors 16 are disposed on the pullout bracket rather than disposed as described in the above variants.

Still further implementation variants are contemplated, most of which being consistent with any of the foregoing alternative embodiments. Many of these variants are facilitated by the inclusion of an integrated electronics system 22 into the carrying case 10, it is contemplated that electronics system 22 may be used to support additional advantageous features of the carrying case.

Indicator 26 can be used to indicate the weight of carrying case 10 and/or its contents using any measurement units including pounds (lb(s)) and/or kilograms (kg(s)) and can display information in one or more languages using many different international character sets as per the users desired choice and settings.

I In another embodiment, electronics system 22 may be modified to include time and date stamped weight memory functionality. This would enable the bag to store in memory the weight at the time the user closes his or her bag and then record the change in weight when the user opens his or her bag. This would be very valuable to the user as he or she will be able to determine if there has been any removal or theft of items in their bag or whether someone has placed anything in their bag. This feature may be especially beneficial, for example, to travelers to countries which have strict importation rules, where a breach can lead to harsh penalties. This will prevent unauthorized tampering of a user's bag and prevent the traveler from being an unwitting courier of drugs or illegal substances. The user can be alerted to the weight change prior to passing customs at their destination. The integration of one or more electronic devices such as a clock, calendar, global positioning satellite (GPS) or camera, will be able to inform the user of the precise date, time and location of the breach and possibly capture a photograph or video of the perpetrator.

Furthermore, user input 28 need not be limited to a simple pushbutton. For example, electronics system 22 may be implemented using a relatively small microprocessor or microcontroller capable of performing programmable functions. User input 28 could include an interface to an external programming unit, or to a handheld device such as a PDA, or to a computer (and, thereby, or directly, could receive or transmit information and programming via the Internet or other networks), permitting a user to re-program the functionality of the electronics system 22.

Likewise, indicator 26 can be used to do more than indicate the weight of carrying case 10 and/or its contents. For example, if a programmable electronics system 22 is provided, indicator 26 could comprise an electronic display of sufficient resolution to display the name, address and/or other contact information about the owner, thereby serving as an electronic “luggage tag.”

For example, in one embodiment, electronics system 22, audio and/or visual indicator 26 and user input 28 may be modified to include biometric identification hardware and software (possibly an optical fingerprint sensor and fingerprint authentication module, or a palm print sensor and authentication module) to identify the owner or user of the carrying case 10. Including biometric identification hardware and software would aid in identification of carrying cases at any time, in crowded areas such as check-in, customs, baggage claim and airport terminals, where many similar or nearly identical cases may be found or to aid security to prove ownership of a bag. The inclusion of an electronic lock or a biometric electronic lock (perhaps with a Transportation Security Administration (TSA) key) would ensure only authorized persons opened the carrying case. Biometric identification hardware and software integrated in a carrying case would improve the U.S.A. government's, TSA, Computer-Assisted Passenger Prescreening System (CAPPS), for instance, since, for example, bags can be easily matched to passengers.

In another embodiment, electronics system 22, may be implemented more robustly to include a personal computer and a wireless modem. In such case, visual indicator 26 may be modified to include a suitably-sized computer display, and user input 28 may be modified to include an input device such as a keyboard, trackball, joystick and or stylus (i.e. a personal computer system). Including a personal computer system would allow a traveler to check-in from anywhere in an airport, and would allow the traveler to track such information as frequent flyer mileage (for example, track accumulated mileage for each airline program, track mileage by respective traveler, and track redemption of miles and awards, etc.) Including a personal computer system would aid in accessing airline information (for example, airline schedules and timetables, select and change seating, airline contact and toll free numbers, baggage weight restrictions and piece allowance for each airline, boarding time, boarding gate information, flight status such as delays, terminal information, flight arrival and departure information, transfer information, notification of acceptance or denial if flying stand-by etc.). Including a personal computer system would allow the user to conveniently access the Internet (i.e. access the World Wide Web) and send and retrieve e-mails from their carrying case. Including a personal computer system would aid the traveler to input and/or edit and/or retrieve information relating to a travel itinerary (for example, flight information, confirmation numbers, airline record locators, hotel confirmation numbers and car rental reservation numbers, etc.). Including a personal computer system would aid the traveler to input and/or edit and/or retrieve electronic lists (for example “to do” list(s), packing reminder list(s), gift list(s), and/or a “to buy” or purchase list(s) for items needed while on a trip), all from the convenience of the carrying case, without the necessity of a separate laptop computer or handheld computing device which could be easily misplaced or lost. Including a personal computer system will allow a hotel to transmit information to guests via the carrying case to provide relevant information, for instance room availability, check out time, billing information, airport shuttle information, and so on. Upon arrival in a destination city, carrying case 10 can receive information relating to local travel information such as accommodations, dining and entertainment.

In another alternative embodiment, electronics system 22 may be modified to include a clock with alarms. Such a clock could display times in different time zones of the world. The inclusion of a clock with alarms will aid the traveler in that he or she will not have to pack a travel alarm clock and will allow the traveler to set wake up reminders as well as other alarm reminders. The inclusion of a GPS would allow the clock to automatically display the local time wherever the traveler is.

In yet another alternative embodiment, electronics system 22 may be modified to include a GPS. The inclusion of a GPS will allow the user to automatically record approximate miles flown, or to provide a traveler with navigation directions upon arrival at an airport or at any other unfamiliar location. The inclusion of a GPS will enable one to record the exact location of a bag using GPS coordinates and then transmit via radio frequency or other means, for example, text message, SMS, and/or e-mail, the exact location of the bag. This can be very beneficial to travelers with extremely valuable luggage contents. The inclusion of a GPS with an electronic lock will be able to tell the user where a bag was when it was opened. The inclusion of a GPS in a carrying case is believed to be of great potential benefit to a parent or guardian for the purposes of tracking an unaccompanied minor who is traveling alone.

In still another alternative embodiment, electronics system 22 may be modified to include a radio frequency identification (RFID) tag storing a unique identifier for the carrying case 10. Including an RFID tag would facilitate tracking of carrying case 10, for example at an airport, and would aid in identification of carrying cases in crowded areas, such as airport terminals, where many similar or nearly identical cases may be found. An RFID tag, in conjunction with a key fob or other device carried on the carrying case owner's person, would also facilitate determining when carrying case 10 has emerged from the baggage carousel commonly used in airport baggage claim areas or allow the user to determine that their bag has been placed in the luggage hold. An RFID tag would also support implementation of an alarm system indicating when carrying case 10 has left the owner's vicinity, aiding in the prevention of theft or of inadvertently leaving carrying case 10 in a taxi or on a bus or train. Including an RFID tag would help an airline and airport determine where a bag can and cannot be taken and help determine when a case is in or outside a predetermined area. For instance at bag check-in the airline can activate electronics in the bag so that the bag cannot be taken into restricted areas or alternatively the bag cannot be taken into restricted areas if the person has not yet checked in. Further airlines and airport security will now be able to ensure that passengers do not try and carry on bags that have not been disclosed at check in. The RFID tag can be combined with TSA encrypted electronics. For instance under the TSA Computer-Assisted Passenger Prescreening System, it may be mandatory for a CAPPS passenger to own a carrying case equipped with the described RFID functionality. At check-in a photo of the traveler or a code resulting from face recognition software can be coded into the electronics within the bag ensuring that the bag does not change hands and remains with the same traveler when they clear security, customs, and board the aircraft.

In yet another alternative embodiment, electronics system 22, may be modified to include a personal computer system with a radio frequency identification (RFID) tag storing a unique identifier for the carrying case 10, and/or an electronic transmitter and/or an electronic receiver. This would allow airlines to communicate information regarding airport lounges directly with travelers through their carrying case. It would assist the traveler in locating participating lounges in an airport and allow the traveler to see on their display, or to hear, whether they are allowed access to the lounge so as to avoid the embarrassment of having to ask a person at the lounge and being turned away. It would allow the traveler to check-in to a lounge electronically without having to notify the lounge attendant. Further, many lounges are closed at times when travelers need them. The electronics in the case may allow the user access to lounges, allow the airlines to keep track of which travelers are using their lounges and allow the airlines to extend the hours their lounges are open or have unmanned lounges.

For example, in another embodiment, electronics system 22 may be modified to include a personal computer and a wireless modem, microphone, speaker, and headphone jack, and audio and/or visual indicator 26 may be modified to include a computer screen, and user input 28 may be modified to include an input device such as a keyboard, trackball, joystick and or stylus (i.e., a personal computer entertainment system). This will allow the user to record and play back digital audio. This will allow a person to record reminders, notes, flight information and confirmation numbers relating to their travel such as airline record locators, hotel confirmation numbers and car rental reservation numbers. A digital audio recorder/player will also act as a vocal name tag to allow for the traveler to correctly identify their bag by activating the feature and hearing their name played. An audio recorder can also store messages from loved ones, directions, positive affirmations, religious or spiritual affirmations, and relaxation or meditation advice for anxious flyers. The inclusion of a video display can also allow the user to view video entertainment, television, photos of loved ones, airport maps and airport store directories, and to surf the Internet which can be updated via broadcast, wirelessly or via an interface for example, a USB interface. Audio and/or video electronics such as an integrated videogames console, a digital video player, MP3 or digital audio player, microphone and audio recorder, soothing sounds generator, and the like, may also be included. Advertising sponsorship could defray the cost of the bag or the system. Many of these functions are both real-time and non-real time, some being broadcast by equipment in the airport or its vicinity and transmitted wirelessly, via Bluetooth or GPRS or 3G, or via wires such as with a USB connection. The carrying case electronics can be used for bag matching purposes where the rightful owner can identify their bag. For example the bag can display a name or some unique visual graphic or will play an audible sound when the traveler presses, say a key fob or other remote device which has been previously programmed to communicate with the corresponding bag or activates a switch on the bag playing a recognizable sound or displaying a recognizable graphic.

In still another alternative embodiment, electronics system 22 may be modified to include an electronic digital or video camera. This will allow the traveler to take digital photos and video. With an integrated electronic camera a parent of an unaccompanied minor could get updated photos and/or video of their child transmitted to them as the child travels.

In still another alternative embodiment, electronics system 22 may be modified to include an electronic passport, and/or visa.

In yet another embodiment, audio and/or visual indicator 26 may be modified so that a part of the carrying case or the entire carrying case can be made of flexible electronics fabric that can display images or can be an integrated flexible screen such as those recently developed by researchers at France Telecom (see, e.g., http://www.francetelecom.com).

In another embodiment, electronics system 22 may be modified to include electronics to eliminate or reduce odors from dirty or smelly clothes, for example an odor-neutralizing ionizer or an odor-neutralizing air purifier such as those made by the Discovery Channel (see, e.g., http://www.discovery.com).

In another embodiment, electronics system 22 may be modified to include robotic motors so that a suitcase can follow or remain by the traveler's side at all times for example when he or she is in an airport or a hotel.

From the foregoing description of specific embodiments of the invention, it should be apparent that a carrying case having an integrated electronics system which renders the carrying case capable of indicating its weight has been disclosed. Although specific embodiments have been described herein in some detail, this has been done solely for the purposes of illustrating the various advantageous aspects and features of the invention, and is not to be construed as limiting the scope of the invention as defined by the claims which follow.

It is contemplated that various alterations, substitutions, and/or modifications, including but not limited to the implementation variants and options specifically noted in this disclosure, may be made to the disclosed embodiments of the invention without departing from the spirit and scope of the invention as defined in the claims.

What is claimed is:

1. A carrying case, comprising:
an enclosure for containment of articles to be carried, said enclosure having at least one support allowing said enclosure to rest on a surface;
at least one load/force sensor disposed between said enclosure and said at least one support, such that the weight of said enclosure and any articles contained therein exerts a force on said at least one load/force sensor, said at least one load/force sensor being selectively responsive to said force to generate at least one load/force signal proportional to the magnitude of said force;
an electronic circuit including an indicator, coupled to said at least one load/force sensor, said electronic circuit being responsive to said at least one load/force signal to cause said indicator to indicate the magnitude of said force.

2. A carrying case in accordance with claim 1, wherein said electronic circuit is contained within said enclosure.

3. A carrying case in accordance with claim 1, wherein said enclosure has at least one substantially flat surface on which said at least one support is carried.

4. A carrying case in accordance with claim 1, wherein said electronic circuit is responsive to an actuator to cause said at least one load/force sensor to generate said at least one load/force signal.

5. A carrying case in accordance with claim 4, wherein said actuator comprises a pushbutton disposed on an outer surface of said enclosure.

6. A carrying case in accordance with claim 1, wherein said indicator comprises a display that is visible to a user.

7. A carrying case in accordance with claim 1, wherein said indicator comprises a voice synthesizer circuit that reads an audible indication of the magnitude of said force.

8. A carrying case in accordance with claim 6, wherein said indicator further comprises a voice synthesizer circuit for reading an audible indication of the magnitude of said force.

9. A carrying case in accordance with claim 1, wherein said visual display comprises a digital display.

10. A carrying case in accordance with claim 9, wherein in said display is a liquid crystal diode display.

11. A carrying case in accordance with claim 1, further comprising at least one substantially rigid force transfer structure disposed between said enclosure and said at least one load/force sensor, such that said force corresponds to substantially all of the weight of said enclosure and any articles contained therein.

12. A carrying case in accordance with claim 1, wherein said enclosure functions to transfer the force corresponding to the weight of said enclosure and any articles contained therein to said at least one load/force sensor.

13. A carrying case in accordance with claim 1, wherein said at least one load/force sensor comprises a piezoelectric transducer.

14. A carrying case in accordance with claim 1, wherein said at least one support comprises at least two wheels for enabling said carrying case to be rolled over a distance.

15. A carrying case in accordance with claim 1, further comprising a power supply for supplying power to said electronic circuit and to said at least one load/force sensor.

16. A carrying case in accordance with claim 1, wherein said at least one load/force sensor comprises a plurality of load/force sensors.

17. A carrying case in accordance with claim 16, wherein said at least one support comprises separate supports for each of said plurality of load/force sensors.

18. A carrying case in accordance with claim 17, wherein said plurality of load force sensors comprises at least four load/force sensors.

19. A carrying case in accordance with claim 1, wherein said indicator comprises a dot-matrix liquid crystal diode display.

20. A carrying case, comprising:
an enclosure for containment of articles to be carried, said enclosure having a handle on a top side thereof;
at least one load/force sensor disposed between said enclosure and said handle, such that the weight of said enclosure and any articles contained therein exerts a tension force on said at least one load/force sensor, when said carrying case is held above the ground by said handle, said at least one load/force sensor being selectively responsive to said force to generate at least one load/force signal proportional to the magnitude of said force;
an electronic circuit including an indicator, coupled to said at least one load/force sensor, said electronic circuit being responsive to said at least one load/force signal to cause said indicator to indicate the magnitude of said force.

21. A carrying case in accordance with claim 20, wherein said electronic circuit is contained within said enclosure.

22. A carrying case in accordance with claim 20, wherein said electronic circuit is responsive to an actuator to cause said at least one load/force sensor to generate said at least one load/force signal.

23. A carrying case in accordance with claim 20, wherein said actuator comprises a pushbutton disposed on an outer surface of said enclosure.

24. A carrying case in accordance with claim 20, wherein said indicator comprises a display that is visible to a user.

25. A carrying case in accordance with claim 20, wherein said indicator comprises a voice synthesizer circuit that reads an audible indication of the magnitude of said force.

26. A carrying case in accordance with claim 24, wherein said indicator further comprises a voice synthesizer circuit that reads an audible indication of the magnitude of said force.

27. A carrying case in accordance with claim 20, wherein said indicator comprises a digital display.

28. A carrying case in accordance with claim 27, wherein said display is a liquid crystal diode display.

29. A carrying case in accordance with claim 20, further comprising at least one substantially rigid force transfer member disposed between said enclosure and said at least one load/force sensor, such that said force corresponds to substantially all of the weight of said enclosure and any articles contained therein.

30. A carrying case in accordance with claim 20, wherein said enclosure functions to transfer the force corresponding to the weight of said enclosure and any articles contained therein to said at least one load/force sensor.

31. A carrying case in accordance with claim 20, wherein said at least one load/force sensor comprises a piezoelectric transducer.

32. A carrying case in accordance with claim 20, wherein said at least one support comprises at least two wheels for enabling said carrying case to be rolled over a distance.

33. A carrying case in accordance with claim 20, further comprising a power supply for supplying power to said electronic circuit and to said at least one load/force sensor.

34. A carrying case in accordance with claim 20, wherein said at least one load/force sensor comprises a plurality of load/force sensors.

35. A carrying case in accordance with claim 34, wherein said at least one support comprises a separate support for each of said plurality of load/force sensors.

36. A carrying case in accordance with claim 35, wherein said plurality of load force sensors comprises at least four load/force sensors.

37. A carrying case in accordance with claim 20, wherein said visual display comprises a dot-matrix liquid crystal diode display.
